(19) United States
(12) Patent Application Publication
(10) Pub. No.: US 2002/0182962 A1
(43) Pub. Date: Dec. 5, 2002

(54) Moisture-absorbing cellulose-based material

(75) Inventors: Robert Woodall, Panama City, FL (US); Felipe Garcia, Panama City, FL (US)

Correspondence Address: COASTAL SYSTEMS STATION, DAHLGREN DIVISION, NAVAL SURFACE WARFARE CENTER, 6703 W HWY 98 CODE CP2L, PANAMA CITY, FL, 32407-7001, US

(73) Assignee: The United States of America represented by the Secretary of the Navy

(21) Appl. No.: 09/839,737

(22) Filed: Apr. 23, 2001

(51) Int. Cl. B32B 5/02

(52) U.S. Cl. 442/327

(57) ABSTRACT

A moisture-absorbing material is based on a fibrous cellulosic material having anisotropic moisture-absorbing properties such that its dried-in strain is greatest along one axis thereof. A powder material coats, and can be mixed with, the cellulosic material. The powder material is inert with respect to the cellulosic material and initiates a chemical reaction when exposed to water such that a product of the chemical reaction is water. The material can also be used as a work-producing structure by providing the material in a dry compressed state where the direction of compression is aligned with the axis of the greatest dried-in strain.

### ORIGIN OF THE INVENTION

The invention described herein was made in the performance of official duties by employees of the Department of the Navy and may be manufactured, used, licensed by or for the Government for any governmental purpose without payment of any royalties thereon.

### CROSS-REFERENCE TO RELATED PATENT APPLICATIONS

This patent application is co-pending with two related patent applications entitled “SAFETY AND ARMING DEVICE USING CELLULOSE-BASED SENSOR/ACTUATOR” (Navy Case No. 82769) and “CELLULOSE-BASED WATER SENSOR/ACTUATOR” (Navy Case No. 82771), filed on the same date by the same inventors as this patent application.

### FIELD OF THE INVENTION

The invention relates generally to moisture-absorbing materials, and more particularly to a cellulose-based moisture-absorbing material capable of achieving mechanical work during absorption.

### BACKGROUND OF THE INVENTION

Moisture-absorbing materials are used in a variety of everyday household items such as bath towels, paper towels, diapers, sponges, etc. The design goal of each of these items is to maximize absorption for a given surface area without any concern for how the item grows or expands as a result of such absorption.

In other specialized applications of moisture-absorbing materials, it may be desirable to harness the expansion of the moisture-absorbing material to perform work. For example, a mechanical water sensor described in U.S. Pat. No. 6,182,507, uses compressed cotton balls constrained in an open frame as a means to absorb water and expand where the force of expansion is used to move a piston. However, compressed cotton balls do not provide a reliable means of moisture absorption in harsh underwater environments and, therefore, are not reliable as a means of producing work when subjected to immersion in such environments. This is because the compressed cotton balls rely on surface absorption of moisture for its expansion. However, high-levels of naturally-occurring impurities and man-made pollutants often found in underwater environments can cover the surface area of the cotton thereby impeding the absorption of water.

### SUMMARY OF THE INVENTION

Accordingly, it is an object of the present invention to provide a moisture-absorbing material that can function in moisture environments having impurities.

Another object of the present invention is to provide a moisture-absorbing, work-producing material structure.

Still another object of the present invention is to provide a moisture-absorbing, work-producing material structure that functions reliably in harsh underwater environments.

Other objects and advantages of the present invention will become more obvious hereinafter in the specification and drawings.

In accordance with the present invention, a moisture-absorbing material is based on a fibrous cellulosic material having anisotropic moisture-absorbing properties such that dried-in strain of the cellulosic material is greatest along one axis thereof. In other words, the cellulosic material should be in its Cellulose II form. A powder material coats, and can be mixed with, the cellulosic material. The powder material is inert with respect to the cellulosic material and initiates a chemical reaction when exposed to water such that a product of the chemical reaction is water. The material can be used as a work-producing structure by providing the material in a dry and compressed state where the direction of compression is aligned with the axis of the greatest dried-in strain.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a schematic diagram of one embodiment of a moisture-absorbing material according to the present invention;

FIG. 2A is a schematic chemical diagram of one method of converting a cellulose material's naturally-occurring Cellulose I form to the Cellulose II form utilized by the present invention;

FIG. 2B is a schematic diagram illustrating the conversion of the Cellulose I form to the Cellulose II form utilized by the present invention;

FIG. 3 is a schematic diagram of another embodiment of a moisture-absorbing material according to the present invention; and

FIG. 4 is a schematic diagram of another embodiment of a moisture-absorbing, work-producing material structure in accordance with the present invention.

### DETAILED DESCRIPTION OF THE INVENTION

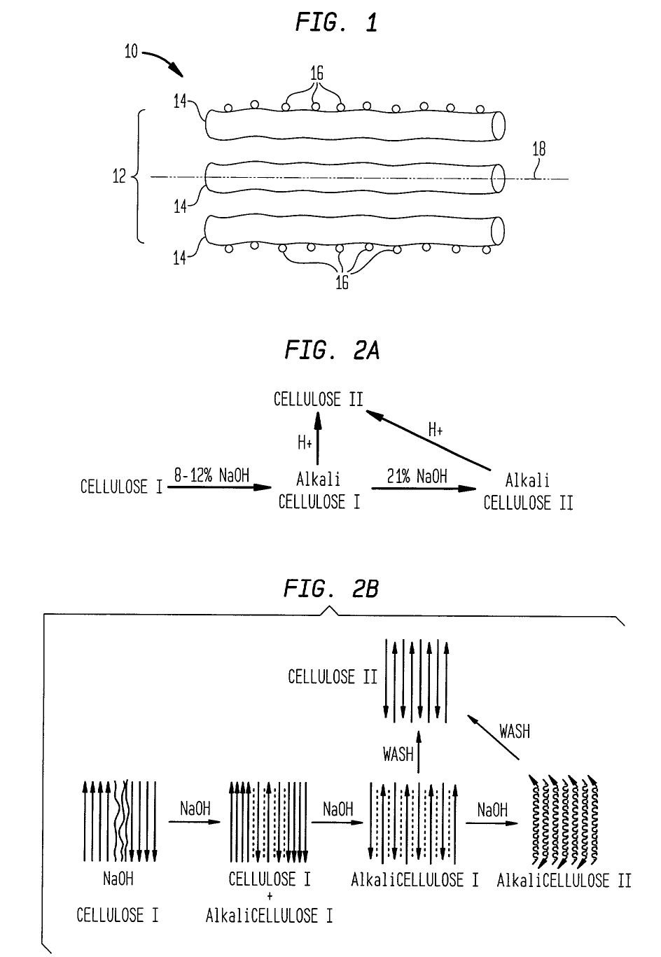

Referring now to the drawings, and more particularly to FIG. 1, a moisture-absorbing material in accordance with one embodiment of the present invention is shown and referenced generally by numeral 10. Moisture-absorbing material 10 is depicted as a microscopic abstraction useful for illustrating the novelty of the present invention.

Moisture-absorbing material 10 is shown in its dry state, i.e., prior to its exposure to a fluid environment such as water. In this state, material 10 is defined by a fibrous cellulosic material consisting of a collection 12 of fibrous tubes 14 with powder particles 16 of a water-reactive material coating or adhering to those portions of tubes 14 defining the exterior surface of material 10.

In general, the fibrous cellulosic material represented by tubes 14 is preferably derived from any plant-based cellulose material that has been processed to exhibit anisotropic behavior/properties in terms of its moisture-absorbing capabilities. More specifically, the fibrous cellulosic material represented by tubes 14 is processed such that the dried-in strain thereof is greatest along an axis 18 of material 10. A variety of processing techniques can be used to achieve this state for fibers 14. Such processing generally includes several of the following processes:

Cleaning foreign matter (e.g., seeds) from the cellulosic material

Water washing the cellulosic material

Surface treating the cellulosic material by means of nitration, bleaching, etc.

Raking or aligning the fibers in the cellulosic material

Stretching the fibers of the cellulosic material along an axis thereof that exhibits the greatest dried-in strain

Drying the cellulosic material

The particular processes and their order can vary depending on the type of cellulosic material, the desired absorption properties, etc., and are therefore not a limitation of the present invention.

As mentioned above, it is preferable that the cellulosic material in the present invention be derived from plants as they are inexpensive, renewable and environmentally safe. The approximate cellulose content for a variety of plant-derived cellulose materials is listed below.

| Material | Percent Cellulose |
|---|---|
| Cotton | 98% |
| Ramie | 86 |
| Hemp | 65 |
| Jute | 58 |
| Deciduous woods | 41-42 |
| Coniferous woods | 41-44 |
| Cornstalks | 43 |
| Wheat straw | 42 |

The greater the percentage of cellulose, the greater the absorption capability. Therefore, the most absorbent type of material 10 will utilize cotton cellulose-based tubes 14.

The state of the dry cellulosic material used in the present invention can also be defined by the form known as Cellulose II. The Cellulose II form is converted or refined from the native form of a cellulose material or Cellulose I. A well known example of Cellulose I to Cellulose II conversion processing is depicted chemically in FIG. 2A and graphically in FIG. 2B. Note that the parallel arrows in the Cellulose II state are indicative of aligned fibrous cellulose tubes such as tubes 14 described above. For further details of cellulose refinement processing, a number of prior art references can be consulted. For example, see “Chemistry of Pulp and Paper Making,” by Edwin Sutermeister, 3rd edition, Wiley Publishing, New York, 1941, or see “Cellulose Chemistry,” by Mark Plungerian, Chemical Publishing Company, Brooklyn, N.Y., 1943.

The material selected for powder particles 16 should be inert with respect to the cellulosic material and reactive with respect to the moisture (e.g., water) to be absorbed. Preferably, the material selected for powder particles 16 should also generate water as a product of its chemical reaction with water. For example, if powder particles 16 comprise a mixture of sodium bicarbonate (NaHCO₃) and citric acid (H₃C₆H₅O₇), a reaction of this mixture with water yields sodium citrate (Na₃C₆H₅O₇), carbon dioxide (CO₂) and water (H₂O). Another preferred example for powder particles 16 is a mixture of sodium bicarbonate (NaHCO₃) and potassium hydrogen tartrate (KHC₄H₄O₆). A reaction of this mixture with water yields potassium sodium tartrate (KNaC₄H₄O₆), carbon dioxide and water. Note that any amount of water is sufficient to start the reaction. Once started, no additional water is needed as the reaction self-produces water.

Upon immersion in water, powder particles 16 solvate with the heat of solvation being released/absorbed from the surroundings to increase or decrease the localized temperature of the reaction zone on the surface of material 10. This localized temperature gradient induces a corresponding mass transfer increase between the hot and cold regions as they pursue thermal equilibrium. The thermal effect increases the mass transfer effect of adsorption at the surface of the cellulose fiber that is in contact with water, i.e., this thermal effect increases the mass transfer effect of adsorption at the boundary that separates the wet versus dry portion of material 10. If powder particles 16 also generate more water when chemically reacting with water, the additional water increases turbulence and changes concentration gradients which, in turn, increase the mass transfer effect of absorption at the surface of material 10.

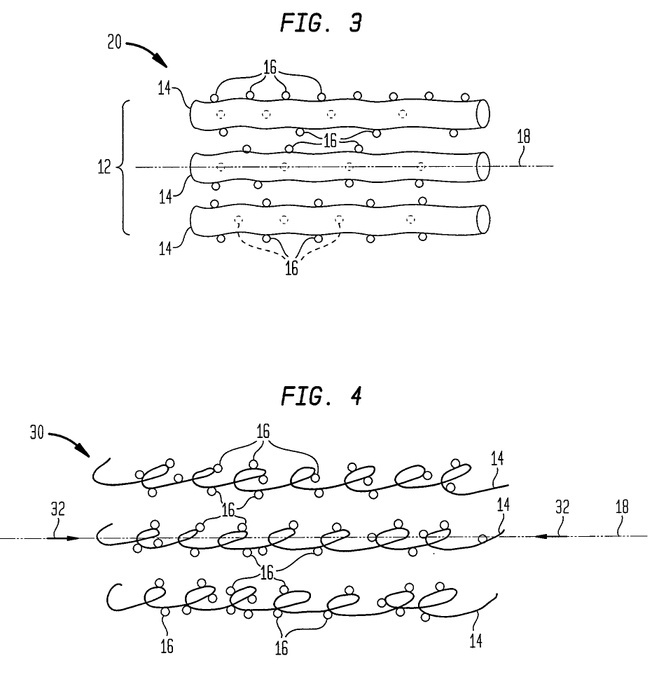

Another embodiment of a moisture-absorbing material according to the present invention is illustrated schematically in FIG. 3 and is referenced generally by numeral 20. Similar to material 10, material 20 includes a fibrous cellulosic material represented by a collection 12 of tubes 14. Powder particles 16 are coated/adhered to the portions of tubes 14 defining the exterior surface of material 20. In addition, powder particles 16 are mixed with tubes 14 to reside therebetween and, in some cases, within tubes 14 as represented by dotted line versions of particles 16. To achieve such a mixed structure, the size of powder particles 16 must be less than (e.g., 10 percent smaller) the porosity of the structure defined by tubes 14. The mixing of powder particles 16 with tubes 14 can be achieved by tumbling the cellulosic material with powder particles 16. Such tumbling processes are standard and well known within the art of cellulose processing.

When immersed in water, adsorption and absorption effects at the surface of material 20 will be the same as material 10. However, the presence of powder particles 16 between and in tubes 14 provides an additional mass transfer effect that increases water adsorption and absorption. In addition, if one of the above-described sodium bicarbonate mixtures is used for powder particles 16, the generation of gaseous carbon dioxide not only improves adsorption and absorption, but also introduces the mass transfer effect of diffusion through material 20.

While each of materials 10 and 20 is useful for pure moisture-absorbing applications, the present invention can also be used as the basis for a moisture-absorbing, work-producing structure. Such a structure is illustrated schematically in FIG. 4 and is referenced generally by numeral 30. By way of example, structure 30 will be described using material 20 as its basis. However, it is to be understood that material 10 could also serve as the basis for structure 30.

Structure 30 is similar to material 20 in that it includes tubes 14 of a cellulosic material coated and mixed with powder particles 16. However, structure 30 has further been compressed along axis 18 (as indicated by arrows 32) which is the axis of greatest dried-in strain or the axis of polymer chain alignment in the case of the Cellulose II form. Accordingly, tubes 14 are illustrated in a “corkscrew” fashion to indicate that they are in a state of compression. However, it is to be understood that compression of tubes 14 is carried out at pressures/forces such that the dried-in strain of tubes 14 along axis 18 is not damaged. That is, compressed tubes 14 can be considered to remain substantially aligned with axis 18.

When structure 30 in its dry state is immersed in water, the above-described mass transfer effects applicable to material 20 also apply to structure 30. However, structure 30 is specifically designed to provide work along axis 18 as the absorption, absorption and diffusion mass transfer effects will cause structure 30 to expand along axis 18. By coating/mixing tubes 14 with powder particles 16 that chemically react with water to produce water, expansion of structure 30 along axis 18 will take place even if there are impurities in the water of activation. Diffusion of the chemically-produced water through structure 30 can be enhanced if a gaseous product such as carbon dioxide is also produced by the chemical reaction. Thus, structure 30 is capable of being used as a reliable water sensing, work-producing element in harsh (i.e, impure and/or polluted) underwater environments.

The advantages of the present invention are numerous. A simple moisture-absorbing material is made from inexpensive/renewable cellulose materials and harmless chemicals. The material can be compressed to provide a work-producing structure that will function reliably even in impure, polluted or harsh water environments.

Although the invention has been described relative to a specific embodiment thereof, there are numerous variations and modifications that will be readily apparent to those skilled in the art in light of the above teachings. It is therefore to be understood that, within the scope of the appended claims, the invention may be practiced other than as specifically described.

What is claimed as new and desired to be secured by Letters Patent of the United States is:

1. A moisture-absorbing material comprising:
a fibrous cellulosic material having anisotropic moisture-absorbing properties wherein dried-in strain of said cellulosic material is greatest along one axis of said cellulosic material; and
a powder material coating said cellulosic material, said powder material being inert with respect to said cellulosic material and initiating a chemical reaction when exposed to water, wherein a product of said chemical reaction is water.

2. A moisture-absorbing material as in claim 1 wherein said cellulosic material is derived from a plant.

3. A moisture-absorbing material as in claim 1 wherein said cellulosic material is cotton cellulose.

4. A moisture-absorbing material as in claim 1 wherein said powder material is selected from the group consisting of: a mixture of sodium bicarbonate and citric acid; and a mixture of sodium bicarbonate and potassium hydrogen tartrate.

5. A moisture-absorbing material as in claim 1 wherein said cellulosic material coated with said powder material is formed as a compressed and dried element wherein a direction of compression is along said axis.

6. A moisture-absorbing material as in claim 1 wherein said cellulosic material has a defined porosity, and wherein said powder material is defined by particles that are smaller in dimension than said defined porosity.

7. A moisture-absorbing material as in claim 1 wherein said powder material is selected such that another product of said chemical reaction is gaseous.

8. A moisture-absorbing material comprising:
a cellulosic material defined by a Cellulose II form; and
a powder material coating said cellulosic material, said powder material being inert with respect to said cellulosic material and initiating a chemical reaction when exposed to water, wherein a product of said chemical reaction is water.

9. A moisture-absorbing material as in claim 8 wherein said cellulosic material is derived from a plant.

10. A moisture-absorbing material as in claim 8 wherein said cellulosic material is cotton cellulose.

11. A moisture-absorbing material as in claim 8 wherein said powder material is selected from the group consisting of: a mixture of sodium bicarbonate and citric acid; and a mixture of sodium bicarbonate and potassium hydrogen tartrate.

12. A moisture-absorbing material as in claim 8 wherein said cellulosic material coated with said powder material is formed as a compressed and dried element.

13. A moisture-absorbing material as in claim 8 wherein said cellulosic material has a defined porosity, and wherein said powder material is defined by particles that are smaller in dimension than said defined porosity.

14. A moisture-absorbing material as in claim 8 wherein said powder material is selected such that another product of said chemical reaction is gaseous.

15. A moisture-absorbing, work-producing structure comprising:
a dry, compressed element of a fibrous cellulosic material having a powder material thereon and mixed therewith, said element being compressed along an axis thereof;
said cellulosic material having anisotropic moisture-absorbing properties wherein dried-in strain of said cellulosic material is greatest along said axis; and
said powder material being inert with respect to said cellulosic material and initiating a chemical reaction when exposed to water, wherein a product of said chemical reaction is water.

16. A moisture-absorbing, work-producing structure as in claim 15 wherein said cellulosic material is derived from a plant.

17. A moisture-absorbing, work-producing structure as in claim 15 wherein said cellulosic material is cotton cellulose.

18. A moisture-absorbing, work-producing structure as in claim 15 wherein said powder material is selected from the group consisting of: a mixture of sodium bicarbonate and citric acid; and a mixture of sodium bicarbonate and potassium hydrogen tartrate.

19. A moisture-absorbing, work-producing structure as in claim 15 wherein said powder material is selected such that another product of said chemical reaction is gaseous.

20. A moisture-absorbing, work-producing structure comprising:
a dry, compressed element of a cellulosic material having a powder material thereon and mixed therewith, said element being compressed along an axis thereof;
said cellulosic material defined by a Cellulose II form having fibrous cellulose tubes substantially aligned with said axis; and
said powder material being inert with respect to said cellulosic material and initiating a chemical reaction when exposed to water, wherein a product of said chemical reaction is water.

21. A moisture-absorbing, work-producing structure as in claim 20 wherein said cellulosic material is derived from a plant.

22. A moisture-absorbing, work-producing structure as in claim 20 wherein said cellulosic material is cotton cellulose.

23. A moisture-absorbing, work-producing structure as in claim 20 wherein said powder material is selected from the group consisting of: a mixture of sodium bicarbonate and citric acid; and a mixture of sodium bicarbonate and potassium hydrogen tartrate.

24. A moisture-absorbing, work-producing structure as in claim 20 wherein said powder material is selected such that another product of said chemical reaction is gaseous.
